(19) United States
(12) Patent Application Publication
(10) Pub. No.: US 2011/0277598 A1
(43) Pub. Date: Nov. 17, 2011

(54) Adjustable socket wrench

(76) Inventor: Ee Jig Kim, West Hills, CA (US)

(21) Appl. No.: 12/800,518

(22) Filed: May 17, 2010

(51) Int. Cl. B25B 13/16; B25B 23/00

(52) U.S. Cl. 81/175; 81/155

(57) ABSTRACT

An adjustable hex wrench structure, in its basic embodiment, requires only two parts: a main body configured with a socket cavity having special modified hex cross-sectional shape, and a user operable clamping screw, traversing a wall of the main body and preferably captivated against loss, with a special pressure disc surface for securing a hex fastener workpiece in place in the modified hex cavity operationally without defacing the workpiece. The main body is made cylindrical in shape and configured with a square driver opening to engage the square end of a conventional socket wrench driver shaft. In a dual socket wrench version, two different-sized modified hex cavities, one in each end portion of the main body, can provide an overall size range greater that 2:1, a single square driver opening being shared, configured in a central bulkhead in the main body: to deploy either cavity, the square end of the driver shaft can be inserted through the opposite cavity to engage the square driver opening in the known detented manner.

### FIELD OF THE INVENTION

The present invention relates to the field of hand tools and more particularly the field of hand-operated wrenches for driving hexagonal nuts and bolt-heads of various sizes, which conventionally requires large sets of graduated fixed-size sockets or box-end wrenches. The present invention discloses improvements in an adjustable socket wrench, previously patented by the present inventor, that can be readily adjusted to accommodate a wide range of sizes of hex fasteners, thus enabling a single unit to avoid the need for a substantial quantity of different sized fixed sockets or box-end wrenches. The improvements include novel structure in the adjustment screw for facilitating manual or tool-driven adjustment, for protecting the clamped facet of a hex fastener object against defacement, and for captivating the adjustment screw against removal and loss thru misplacement.

### BACKGROUND OF THE INVENTION

Conventional fixed wrenches, whether of the spanner, box-end or the socket type that snap onto a square driver shaft, have the disadvantage that a large number of different sized wrenches or sockets are required to cover a working size range of hex fasteners. For example in the inch system, the range from ⅜ to ¾ inches (0.375″ to 0.750″) requires seven sockets in steps of 1/16″ or thirteen sockets in steps of 1/32″; and, in the numbered metric system, the range from 10 mm to 20 mm (0.394″ to 0.787″) requires eleven sockets in steps of 1 mm.

As substitutes for single or dual fixed spanner wrenches, adjustable spanners, including “monkey wrenches”, “vice grips” and pipe wrenches, have been well known and widely used for many years. However such adjustable spanners effectively engage only two of the six facets of hex fasteners and thus tend to fail and/or damage the fastener when high torque is required and applied, whereas conventional box-end or socket wrenches engage all six facets of the hex fastener, distributing the torque and associated forces more evenly, and are thus capable of higher torque with less likelihood of failure or fastener damage.

As substitutes for single or dual fixed box-end wrenches, which engage all six facets of hex fasteners, socket wrench systems, wherein any of an assortment of sockets can be snapped onto the square end of a drive shaft driven by a ratchet handle, have become highly popular, especially to professional mechanics, for their convenience and versatility and are readily available either in individual pieces or in sets of various sizes required to accommodate a desired size range. However, the large number of pieces required is a disadvantage to many occasional users such as typical homeowners who may have only occasional need for a wrench but the required size is unpredictable.

### DISCUSSION OF KNOWN ART

U.S. Pat. No. 6,923,096 to the present inventor, Ee Jig Kim, for an ADJUSTABLE SOCKET WRENCH, discloses an adjustable box wrench structure with only two parts in its basic embodiment: a main body configured with a socket cavity having special modified hex cross-sectional shape that is asymmetric about one axis, and a user-actuated clamping screw, traversing a wall of the main body, for securing a hex fastener in place in the socket cavity. The present disclosure is directed to further improvements applicable to the adjustable socket wrench disclosed in the '096 patent.

U.S. Pat. No. 4,798,108 to Wilson for an ADJUSTABLE SOCKET-FORMING DEVICE discloses a hex socket wrench structure having a cylindrical main body, configured at one end with four facets of a hexagon, in which a radially sliding jaw member is configured in one end region with the other two facets of the hexagon while the opposite end region of the jaw member is threadedly engaged by a screw, radially traversing an opposite side of the main body in a mid region thereof, by which the jaw member can be tightened onto a hex fastener that is to be driven.

U.S. Pat. No. 4,967,625 to Kolari & Kolari discloses an ADJUSTABLE JAW SOCKET having a fixed jaw configured to grip a first adjacent pair of hex faces of a fastener and a slidingly-constrained worm-driven jaw configured to grip a second and opposite adjacent pair of hex faces of the fastener.

Both of the above described devices have the disadvantage of complexity: requiring at least three separate parts of which two demand high precision machining to form complementary channels for accurately constraining the sliding movement.

U.S. design Pat. 338,146 to Gramera shows an EQUILATERAL TORQUE DRIVE DOUBLE ENDED SOCKET WRENCH FOR HEXAGONAL FASTENERS of generally tubular shape having a central bulkhead configured with a square opening for engagement by a driver from either end, and also configured externally with a central hex collar as an alternative driving means. Two different sized sockets are provided, one at each end, each of generally triangular shaped for engaging three of the six sides of a hex fastener. This approach offers the advantage of simple one-piece construction with no moving parts, however, in tradeoff, the range of hex fastener sizes accommodated, while not specified in this design patent, appears to be limited to two sizes or, at most, two very narrow ranges.

### OBJECTS OF THE INVENTION

It is a primary object of the present invention to provide a simple, strong, compact and economical adjustable hex wrench structure that accommodates a predetermined size range of hex fasteners such as nuts and bolt heads, as an alternative to a graduated set of multiple fixed hex box-end or socket wrenches.

It is a further object to provide an adjustable socket wrench embodiment for use with a conventional ratchet or fixed handle driver with a shaft having a square end for engaging the socket, typically retained by a spring-loaded-ball/groove type detent configuration.

It is a further object to provide a user-operable clamping-adjustment member with special protective structure at the working end to avoid facet defacement of a driven hex fastener workpiece.

It is a further object to configure the clamping-adjustment member in a manner to provide optimal thumb/finger gripping for manual operation for adjustment as well as providing options of driving the clamping-adjustment member with conventional screwdriver type tools.

It is a further object to provide a dual embodiment of the adjustable socket wrench that accommodates all sizes of hex fasteners within a designated ratio of overall size range.

### SUMMARY OF THE INVENTION

The foregoing objects have been met in the present invention of an adjustable socket wrench, for driving hex fastener workpieces, which, in its basic embodiment, consists of only two main components: (1) a main body configured with a square driver socket to be driven from a conventional square driver, combined with a working socket cavity having a special modified hex cross-sectional shape characterized by asymmetry with two oversized facets flanking an undersized facet and (2) a clamping screw, constituting the clamping-adjustment member, threadedly engaged in a radial bore traversing a wall of the main body diametrically opposite the undersized facet. At its outer end, the clamping screw is configured with an annular drive wheel portion featuring a knurled surface around the outer circumference to enhance finger-gripping. At its inner end, the clamping screw is configured with a special smooth pressure disc surface, made and arranged to distribute adequate working pressure applied to the clamped facet of a hex fastener workpiece in a protective manner that avoids defacing the facet.

The clamping screw is further configured at its outer end with a recessed drive pattern that accepts optional engagement of either a regular slot type or Philips type screwdriver.

The adjustable socket wrench can be dimensioned to provide a range of about 1.7:1 so that two wrenches can be dimensioned with complementary ranges that will accommodate all hex fasteners sizes in a total range covering at least 3:1 ratio: e.g. 5/16 to 1 inch.

In a single socket wrench unit, the square driver opening is located at an end of the unit. In dual socket wrench unit, the square driver unit is located in a central bulkhead between the two modified hex cavities, so that, whichever one of these two cavities is selected to drive a hex fastener workpiece, the square end of a conventional socket driver shaft can be inserted through the other modified hex cavity at the opposite end region of the dual unit and engaged into the square driver opening in the bulkhead to drive the adjustable socket in essentially the same manner as a conventional single fixed-size socket.

### BRIEF DESCRIPTION OF THE DRAWINGS

The above and further objects, features and advantages of the present invention will be more fully understood from the following description taken with the accompanying drawings in which:

FIG. 1 is an elevational side view of an adjustable socket wrench in a preferred embodiment of the present invention.

FIG. 2 is a top view of the socket wrench of FIG. 1.

FIG. 3 is a bottom view of the socket wrench of FIG. 1.

FIG. 4 is a cross-section taken through axis F4-F4 of FIG. 2.

FIG. 5 is a cross-section taken through axis F5-F5 of FIG. 1.

FIG. 6 is a cross-section taken through axis F6-F6 of FIG. 1.

FIG. 7 is a cross-section as in FIG. 4 showing the pre-assembly condition of the clamping screw and the pressure disc.

FIG. 8 depicts the tool-driving pattern configured at the outer end of the clamping screw of FIGS. 1-7.

FIG. 9 depicts the geometric shape of the modified hex cavity in FIGS. 2, 3, 5 and 6.

FIGS. 10-12 show a bottom view of the adjustable socket wrench of the present invention as in FIG. 3, shown here deployed and engaging hex fastener workpieces of maximum, medium and minimum size, respectively.

FIG. 13 is a side view of a dual embodiment of the adjustable socket wrench of the present invention.

FIG. 14 is a cross-section taken through the drive bulkhead at axis F14-F14 of FIG. 13.

FIG. 15 is a cross-section of the dual socket wrench of FIG. 13 taken through central axis F15-F15 of FIG. 14.

### DETAILED DESCRIPTION

FIG. 1 is an elevational side view of an adjustable socket wrench representing a preferred embodiment of the present invention wherein there are essentially two component parts: a cylindrical main body 10 into which is threaded a radially oriented clamping screw 12 configured at its outer end with a grip knob 12A having an outer circumference that is preferably knurled as shown or otherwise configured to facilitate manual adjustment of the clamping screw 12. The main body 10 and the clamping screw 12 are machined preferably from high grade tool steel.

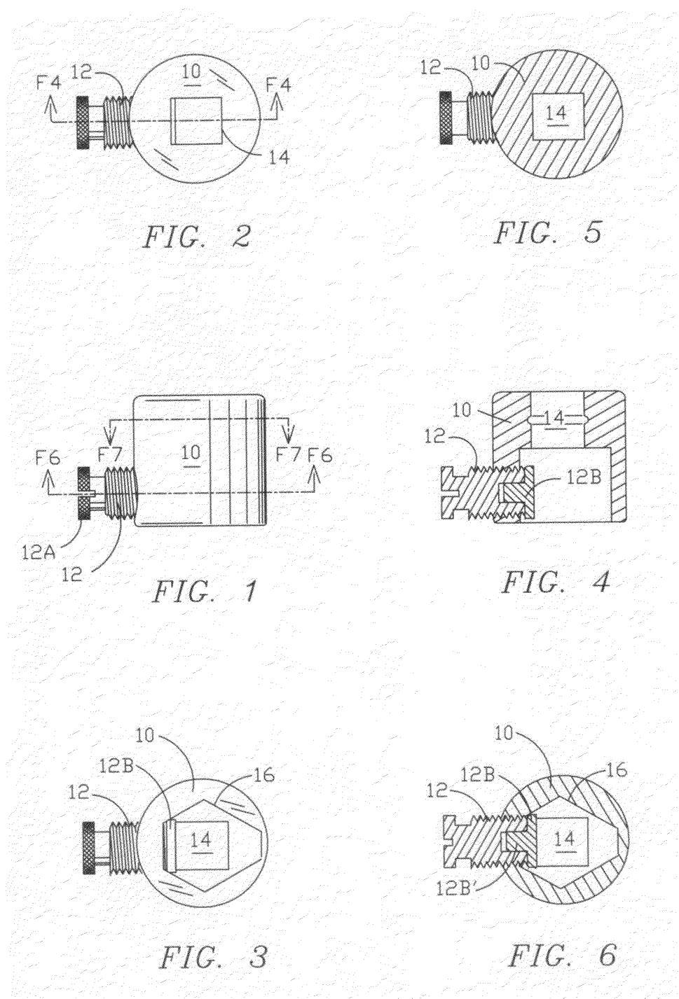

FIG. 2 is a top view of the socket wrench of FIG. 1 showing the clamping screw 12 and a square drive socket opening 14 that accepts a conventional socket wrench driver shaft.

FIG. 3 is a bottom view of the socket wrench of FIG. 1 showing clamping screw 12 located radially and traversing the center facet of the three adjacent equal-sized facets of the modified hex cavity 16 that is unique to the present invention. At the inner end of clamping screw 12, at the left side of modified hex cavity 16, a circular pressure disc 12B of clamping screw 12 provides a lateral clamping surface. The square drive socket opening 14 appears in the background.

FIG. 4 is a cross-section of FIG. 1 taken at axis F4-F4 of FIG. 2 (center of clamping screw 12), showing, in the upper part of main body 10, the square driver socket opening 14 configured with grooves 14A that are provided across each of the four walls to engage a spring-loaded ball in the driver and thus provide the well-known detented retension of the socket wrench on the driver shaft. Pressure disc 12B is seen configured with a central stud 12B′ by which it is retained in a boring at the inner end of clamping screw 12.

FIG. 5 is a cross-section of FIG. 3 taken through axis F5-F5 of FIG. 1, showing the upper part of the main body 10 surrounding the square drive socket opening 14, with clamping screw 12 showing in the background.

FIG. 6 is a cross-section of FIG. 3 taken through axis F6-F6 of FIG. 1 at the center of clamping screw 12, shown traversing the main body 10 at the central one of three equal facets of the modified hex cavity 16. The square drive socket opening 14 appears in the background.

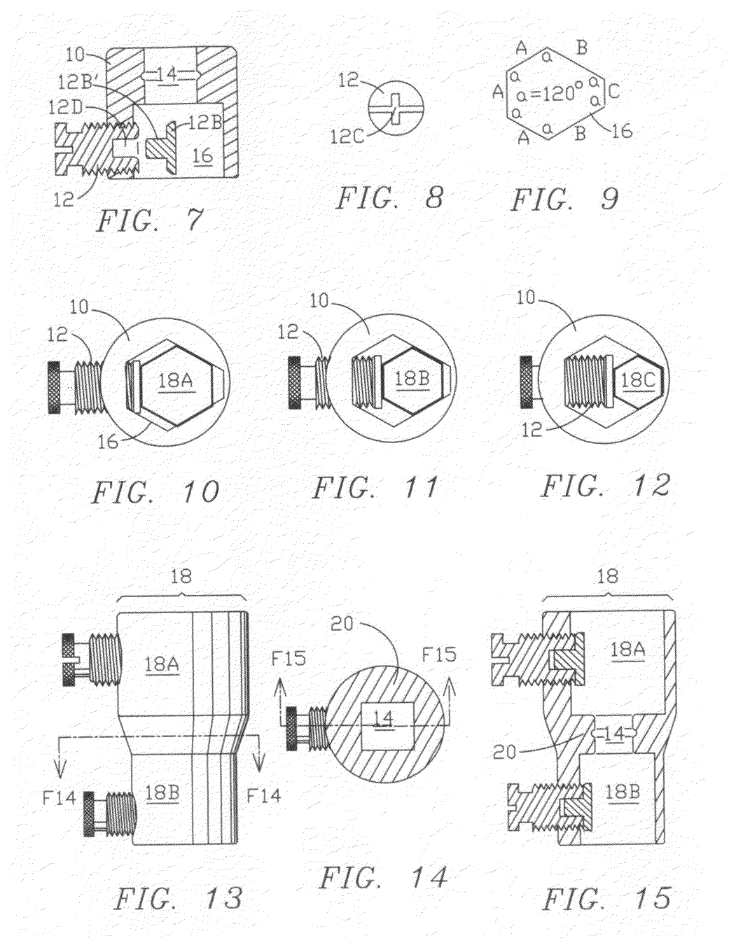

FIG. 7 is a cross-section as in FIG. 4 showing the pre-assembly production condition of the clamping screw 12 threaded through main body 10 and entering the modified hex cavity 16, where the pressure disc 12B is positioned ready to be assembled together with clamping screw 12. In this process, stud 12B′ extending from the rear side of pressure disc 12B is inserted into boring 12D of the clamping screw 12 and pressed into place as shown in FIGS. 4 and 6, with optional bonding or adhesives. Once joined together, the two pieces are intended to remain assembled permanently and to function equivalent to a single integrated part.

Pressure disc 12B is made at least as large in diameter as the outside diameter of clamping screw 12 so to enhance the distribution of clamp pressure to avoid defacing the facet of a hex fastener being clamped in deployment of the socket wrench. Furthermore, such dimensioning of pressure disc 12B serves to retain the clamping screw 12 captive in the main body 10, preventing removal and possible misplacement/loss of clamping screw There is an option of forming the pressure disc 12B integrally with clamping screw 12 and, at the outer end, making the grip knob small enough in diameter to clear the threads or else removably attached so that in manufacture the clamping screw 12, with the disadvantages of having to be made sufficiently short and having to be installed from inside the modified hex cavity 16.

FIG. 8 depicts the tool-driving pattern 12C configured at the outer end of the clamping screw 12 of FIGS. 1-6, provided as an option to manual clamping adjustment and enabling the use of either a regular blade screwdriver or a Philips driver. Another option is to provide a hex opening for an Allen type driver. As an option for manual operation instead of the knurled knob, the clamping screw could be configured with a transverse bar or other form of thumb-finger grip.

FIG. 9 depicts the geometric shape of the modified hex cavity shown in FIGS. 2, 3, 5 and 6 as the key feature of the adjustable hex socket wrench of the present invention. As in a regular equilateral hex pattern, all six angles a in the modified hex pattern are 120 degrees as indicated. However, in the pattern of the modified hex cavity 16, in a departure from a regular equilateral hexagon with six equal-sized facets, the pattern of the modified hex cavity 16 is characterized by three of the six facets, marked A on the left hand side as shown, being made equal, having in common the regular standard dimension, while on the right hand side there are three non-standard-sized facets: two non-adjacent facets marked B that are larger than standard A, flanking the third facet marked C that is smaller than standard A.

The standard facet width A sets the maximum size hex fastener that can be accommodated; the smallest facet width C sets the minimum size, at which the fastener may be engaged by a 3 facet constraint pattern in the main body. Thus the range of fastener sizes that can be accommodated in one modified hex socket cavity is the ratio A/C (>1).

From trigonometry, in a regular hex fastener of size D (distance between parallel facets) each facet width A=D/(2*cos 30) i.e. D*0.57735; in the modified hex shape of this invention, once C is designated to set the range, B can be calculated: B=2*A−C.

In a particular embodiment that accommodates hex fasteners throughout a size range from 5/16″ to ⅝″, i.e. 2:1 ratio, the three equal facets A are made 0.478″ wide, and the small facet C is made 289″. The main body 10 is made 1.25″ in diameter and the clamping screw is made 0.5″ in outer diameter with 13 threads per inch.

FIGS. 10-12 show a bottom view of main body 10 of the adjustable socket wrench of the present invention as in FIG. 3, showing how the modified hex cavity 16 and clamping screw 12 are deployed to accommodate hex fasteners 18A, 18B and 18C of maximum, medium and minimum size, respectively.

FIG. 13 is an elevational side view of a dual adjustable wrench 18 representing a particular embodiment of the present invention. A generally cylindrical main body 18 with a tapered central step contains two different sized adjustable wrenches: a larger upper portion 18A and smaller lower portion 18B, each with an associated clamping screw and a modified hex cavity, scaled in size accordingly, but otherwise configured as described above for a single unit adjustable wrench.

FIG. 14 is a cross-section taken through the drive bulkhead 20 at axis F14-F14 of FIG. 13 in the tapered region, showing the bulkhead 20 traversed by the square socket drive opening 14 which is shared by the two adjustable wrench units. Whichever one of the two units is deployed, the socket drive shaft is inserted through the opposite modified hex cavity and into the square socket drive opening 14. As described above for the single embodiment, a set of grooves configured centrally in the four walls of the square opening 14 serve to provide retention by engaging the well-known spring-loaded ball detent of the conventional socket drive shaft which can be inserted and operated from either direction,

FIG. 15, a cross-section of the dual socket wrench 18 of FIG. 13 taken through central axis F15-F15 of FIG. 14, shows the larger modified hex cavity region of the upper portion 18A and the smaller modified hex cavity region of the lower portion 18B, each equipped with a corresponding clamping screw as described above. The two cavity regions are separated by bulkhead 20 which is seen configured with the square drive opening 14 and its detent grooves.

For dual adjustable wrench embodiments, the size ranges of the two modified hex cavities would normally be made complementary to maximize the continuous overall hex fastener size range: thus for a size range ratio D1/D2 in the larger socket cavity, the size range ratio for the smaller socket cavity is made to be D2/D3 for a total range ratio D1/D3. Size D2 is termed the crossover size, being at the low end of the higher range and at the high end of the lower range.

In an exemplary embodiment, the upper portion 18A is made 1.5″ in diameter and the lower portion 18B is made 1.1″ in diameter. The square drive opening 14 is typically made in either of two popular sizes: ½ inch or ⅜ inch per side, depending on the wrench size.

Although the illustrative embodiment is arranged and dimensioned as described, the invention can be practiced in any size with dimensional variations as matters of design choice, by allowing acceptable amounts of variations in the cavity size ratio and the facet size ratios in each modified hex cavity.

Optionally the taper in the exterior region between portions 18A and 18b could be eliminated to make the outer surface fully cylindrical.

The general proportions can be altered, for example the outer diameter can be increased to provide increased wall thickness around the cavities, which would increase the ultimate strength.

The invention could be practiced with different types and sizes of driving system as alternative to the square drive opening 14. The shape could be made rectangular, triangular, hex or other driving shape to match a complementary driver, as a matter of design choice. Instead of rotational drive via an internal driving opening as described, the adjustable socket wrench could be driven externally by a ratchet mechanism or a gripping device such as a pipe wrench or a self-clamping wrench of the type utilized for installing and removing cylindrical oil filters. Alternatively, the exterior could be configured with a square, hex or other pattern to be engaged for rotation by a corresponding wrench type.

As alternatives to the shaft-driven socket wrench type embodiments described, the modified hex shape of the socket cavity and the clamping screw, as principles of the present invention, can be practiced in the form of a box-end style wrench by the addition of a driving handle extending radially from the cylindrical main body, forming in effect a box-end wrench style which may be implemented with one or two adjustable sockets. A double-ended version of the box-end wrench can be made by incorporating two cylindrical main bodies, one at each end of a handle. Each main body can be made with one or two adjustable sockets, thus a double-ended box-end wrench can be made with a total of two, three or four adjustable sockets of the present invention, providing expanded overall hex size ranges accordingly.

The invention may be embodied and practiced in other specific forms without departing from the spirit and essential characteristics thereof. The present embodiments are therefore to be considered in all respects as illustrative and not restrictive, the scope of the invention being indicated by the appended claims rather than by the foregoing description; and all variations, substitutions and changes which come within the meaning and range of equivalency of the claims are therefore intended to be embraced therein.

What is claimed is:

1. An adjustable wrench structure for engaging and rotationally driving conventional hex fastener workpieces including hex-head bolts and hex nuts of any size within in a predetermined size range, comprising:
a main body configured with at least one modified hex cavity having a cross-sectional shape of an asymmetric hex wherein a group of three adjacent standard-sized facets and a group of three non-standard-sized facets of which an undersized facet is flanked by two equally oversized facets, the main body being configured with a threaded radial bore traversing a wall thereof diametrically opposite the undersized facet;
a clamping screw of designated outside diameter, threadedly engaged in the radial bore of said main body with an outer end extending from said main body, and an inner end made and arranged to enter the modified hex cavity and to therein clamp a hex fastener workpiece for purposes of operationally rotating the hex fastener workpiece, with clamping force, adjustable by user rotation of the clamping screw, being applied to a facet of the hex fastener and thus forcing at least one other facet of the hex fastener against a corresponding main body constraint pattern formed by at least one of the non-standard-sized facets of the modified hex cavity;
a pressure surface disposed laterally at an inner end of said clamping screw made and arranged to optimally apply and distribute adequate working pressure against a corresponding facet of the hex fastener workpiece, as applied by a user rotating said clamping screw, said pressure surface being made sufficiently large and smooth to avoid defacing the facet; and
driving means for applying torque to said main body in a manner to rotationally drive the hex fastener workpiece.

2. The adjustable socket wrench as defined in claim 1 further comprising a gripping portion located at the outer end of said clamping screw, made and arranged to facilitate manual threading rotation thereof by a user for application and adjustment of adequate working clamping pressure to the corresponding facet of the hex fastener workpiece.

3. The adjustable socket wrench as defined in claim 1 further comprising the outer end of said clamping screw being configured with a pattern of driving recesses, made and arranged to receive rotational driving torque from a known type of driving tool in a manner to clamp the hex fastener workpiece in the modified hex cavity securely for rotational driving purposes.

4. The adjustable socket wrench as defined in claim 1 wherein
said main body is generally cylindrical in shape;
said modified hex cavity is located in a first end portion of said main body; and
said driving means comprises said main body being configured with a drive cavity of square cross-section, located coaxially at a second end region of the main body, opposite the first end, made and arranged to operationally engage a square end portion of a conventional socket wrench driving tool.

5. The adjustable socket wrench as defined in claim 1 wherein said pressure surface comprises:
an inwardly-facing smooth flat circular pressure surface of a pressure disc located in a lateral plane at the inner end of said clamping screw, having a diameter at least equal to the designated outside diameter of said clamping screw, made and arranged to become permanently attached to the inner end of said clamping screw whilst said clamping screw is threaded in place in said main body, thus preventing outward removal of the clamping screw from said main body

6. The adjustable socket wrench as defined in claim 1 configured in a dual embodiment wherein, in addition to said modified hex cavity and said clamping screw located at a first end portion of said main body, said adjustable socket wrench further comprises:
a second modified hex cavity and associated captivated clamping screw, generally similar to but differing in size from said modified hex cavity, located in a second and opposite end portion of said main body, made and arranged to complement said first modified hex cavity with regard to range of size accommodation of hex fastener workpieces, and thus provide substantially increased overall range of size accommodation; and
said driving means comprising a transverse circular bulkhead, disposed centrally in said main body between said first modified hex cavity and said second modified hex cavity, configured with a generally coaxial square opening made and arranged to drivingly engage a square end portion of a well-known socket wrench driving tool, such that, whichever socket cavity is selected for deployment to drive a hex fastener inserted therein, the square end portion of the conventional socket wrench driving tool may be inserted through the other socket cavity at the opposite end region of the main body and engaged into the square opening to rotationally drive the adjustable socket wrench.

7. The adjustable socket wrench in a dual embodiment as defined in claim 6 wherein the first end portion of the main body is made to have a first diameter, the second and opposite end portion is made to have a second diameter, smaller than the first diameter, and a central region of the main body is configured to taper from the first diameter to the second diameter.

8. The adjustable socket wrench in a dual embodiment as defined in claim 6 wherein the overall size range is made to have at least a 2:1 ratio.

9. The adjustable socket wrench as defined in claim 5 wherein the pressure disc comprises:
a cylindrical attachment stud extending centrally as part thereof from a side of the pressure disc opposite said pressure surface, made and arranged to be force-fitted, whilst said clamping screw is threadedly engaged and extending into said main body, into a cylindrical opening located at the inner end region of said clamping screw so as to become a permanent part of said clamping screw.
